(19) United States
(12) Patent Application Publication
(10) Pub. No.: US 2024/0315914 A1
(43) Pub. Date: Sep. 26, 2024

(54) STRETCHING DEVICE

(71) Applicant: Bok Sang YU, Gwangyang-si (KR)

(72) Inventor: Bok Sang YU, Gwangyang-si (KR)

(21) Appl. No.: 18/276,680

(22) PCT Filed: Sep. 15, 2021
(86) PCT No.: PCT/KR2021/012605

§ 371 Date: Aug. 10, 2023

(30) Foreign Application Priority Data
Feb. 17, 2021 (KR) 10-2021-0021090

(51) Int. Cl. A61H 15/00

(52) U.S. Cl. CPC A61H 15/00; A61H 2015/0014; A61H 2201/0119; A61H 2201/1261

(57) ABSTRACT

The present invention relates to a stretching device, and more particularly, to a stretching device that enables a user to get stretching exercise by leaning against a foam roller. A stretching device according to the present invention includes a foam roller part having a cylindrical shape with a predetermined length, disposed in parallel with the ground, and configured to be able to support a user's body by allowing the user to lie on an outer circumferential surface of the foam roller part; and a support part configured to rotatably support the foam roller part.

### TECHNICAL FIELD

The present invention relates to a stretching device, and more particularly, to a stretching device that enables a user to get stretching exercise by leaning against a foam roller.

### BACKGROUND ART

In general, a foam roller is known as a cylindrical prop originating from exercises of rolling a log and made of a sponge material that is light in weight and has good shock absorption.

The foam roller is an exercise device that expands an exercise capacity by efficiently stretching each part of the body to relax tense muscle tissue using the cylindrical rolling property.

The foam roller can be used for stretching the whole body, increasing a range of motion of joints, improving a balance ability, and enhancing muscle strength. The foam roller is clinically used to improve, recover, and prevent muscle tension, piriformis syndrome, frozen shoulders, and the like, and is utilized for treatment purposes in patients with stroke and polio. In addition, since the foam roller can easily relax tense muscles, it is used for rehabilitation treatment, posture correction, and the like.

Korean Patent Application Publication No. 10-2015-0108100 discloses a foam roller having a cylindrical shape.

Such a foam roller may be made of a soft material or a hard material depending on a type of a material. The foam roller may have protrusions or wavy curves on a surface in order to effectively relax muscles and fascia.

For example, Korean Patent No. 10-2001390 discloses a spine-correcting orthopedic foam roller for improving metabolism comprising a transverse process stimulating part, a junctional process accommodation groove, and a costal tubercle stimulating protrusion formed on an outer circumferential surface so as to correspond to a spinous process and a transverse process of a vertebra.

Such a foam roller enables stretching exercise in a manner of moving the user's body forward and backward to roll the foam roller in a state where it is usually placed on the floor and the user leans against the outer circumferential surface of the foam roller to support the user's body by the foam roller.

However, when the user gets stretching exercise while moving the user's body forward and backward, the foam roller moves along the ground in the same direction as the moving direction of the user's body. Due to this, the stretching exercise using the foam roller requires a sufficient movement space in the front-rear direction, which limits exercises in a narrow space. In addition, since the foam roller requires the user to consider a moving distance of the foam roller relative to the ground, in addition to a relative moving distance of the user's body relative to the foam roller, it is difficult for the user to estimate the moving distance of the user's body during stretching exercises, leading to a problem in that injuries may occur due to careless impact when getting exercise near the walls.

### DETAILED DESCRIPTION OF THE INVENTION

### Technical Problem

The present invention has been made to solve the above problems, and an object thereof is to provide a foam roller enabling exercises in a narrow space by causing the foam roller to rotate in place even when a user rolls the foam roller by moving the user's body forward and backward.

Another object of the present invention is to provide a stretching device by which a user can easily estimate a moving distance of the user's body by maintaining a position of the foam roller relative to the ground during stretching exercise.

### Technical Solution

A stretching device according to the present invention includes a foam roller part having a cylindrical shape with a predetermined length, disposed in parallel with the ground, and configured to be able to support a user's body by allowing the user to lie on an outer circumferential surface of the foam roller part; and a support part configured to rotatably support the foam roller part.

According to another aspect of the present invention, the support part includes first and second support roller parts each having a rotation axis parallel to the foam roller part and spaced apart from each other and arranged to have axis lines parallel to each other so that an outer circumferential surface along a length direction of the foam roller part can be rotatably supported in a restrained state of the foam roller part, a roller supporter configured to rotatably support the first and second support roller parts.

According to another aspect of the present invention, the support part includes a pair of supporters disposed on both sides of the foam roller part, and a moving part coupled to the supporters to rotatably support the foam roller part, and configured to move together with the foam roller part to prevent movement of the supporters when an external force is applied along a length direction of the foam roller part.

The foam roller part is formed in a tubular shape having a hollow portion penetrating along the length direction, the supporters each include a holder provided with an insertion hole into which the moving part is movably inserted in the length direction of the foam roller part, and a base configured to support the holder, and the moving part includes a support shaft disposed in the hollow portion and having both end portions inserted into and coupled to the insertion holes, a bearing installed on the support shaft to rotatably support the foam roller part, and movement limiting caps installed at both end portions of the support shaft and configured to limit movement of the support shaft in the length direction.

The moving part further includes elastic members installed to elastically support the movement limiting caps with respect to the holders and to attenuate a pressing force transmitted from a user in the length direction of the foam roller part.

The foam roller part is provided in a pair of foam roller parts spaced apart from each other and arranged side by side, and the supporters each include a connecting rod configured to interconnect the holders configured to support the foam roller parts, and a tilting stand configured to support the connecting rod in a tiltable manner.

The support part further includes an interval adjusting part configured to be able to vary an interval between the first support roller part and the second support roller part, the roller supporter includes first and second roller supporters configured to individually rotatably support the first and second support roller parts and spaced apart from each other at a predetermined interval, and the interval adjusting part includes an interval adjusting guide extending by a predetermined length, having one side fixed to the second roller supporter and formed with a plurality of interval adjusting holes spaced apart from each other at regular intervals along a length direction on an outer circumferential surface, and an interval fixing member coupled to an interval fixing hole formed in the first roller supporter so as to be coaxial with at least one of the interval adjusting holes and the interval adjusting hole.

The stretching device further includes an anti-depression part configured to prevent depression of a part between one side and the other side of the foam roller part by a load applied from a user, and the anti-depression part includes first and second anti-depression parts each having a rotation axis parallel to the foam roller part and spaced apart from each other and arranged to have axis lines parallel to each other so that an outer circumferential surface along a length direction of the foam roller part can be rotatably supported in a restrained state of the foam roller part, and an anti-depression roller supporter configured to rotatably support the first and second anti-depression roller parts.

### Advantageous Effects

In the stretching device according to the present invention, the foam roller part is supported to be rotatable in place in a state of being spaced apart from the ground with respect to the support part. With this configuration, even when the user rolls the foam roller part by moving the user's body forward and backward, the foam roller part does not move along the moving direction of the user's body. Therefore, the stretching device according to the present invention has an advantage in that a space required for the user to get stretching exercise is limited to a distance that the user moves the user's body forward and backward for the stretching exercise, and thus the space can be efficiently used.

In addition, the stretching device according to the present invention has an advantage in that a risk of injury by hitting the head against a wall is reduced, because a position of the foam roller part is maintained during the user's stretching exercise and thus it is easy for the user to estimate the moving distance of the user's body.

### BRIEF DESCRIPTION OF DRAWINGS

FIG. 1 is a perspective view of a stretching device according to a first embodiment of the present invention.

FIG. 2 is a perspective view of a stretching device according to a second embodiment of the present invention.

FIG. 3 is a perspective view of a stretching device according to a third embodiment of the present invention, in which main parts are cut and separated.

FIG. 4 is a front cross-sectional view of the stretching device of FIG. 3.

FIG. 5 illustrates a state in which a foam roller part and a moving part of FIG. 4 move in a length direction.

FIG. 6 is a perspective view of a stretching device according to a fourth embodiment of the present invention.

FIG. 7 is an exploded perspective view for illustrating a coupled state of foam roller parts and supporters of FIG. 6.

FIG. 8 is a perspective view of a stretching device according to a fifth embodiment of the present invention, in which main parts are cut and separated.

FIG. 9 is a front cross-sectional view of the stretching device of FIG. 8.

FIG. 10 illustrates a state in which the foam roller part and the moving part of FIG. 9 move in the length direction.

FIG. 11 is a perspective view of a stretching device according to a sixth embodiment of the present invention.

FIG. 12 is a front cross-sectional view for illustrating an interval adjusting part of FIG. 11.

FIG. 13 is a side view of a stretching device according to a seventh embodiment of the present invention.

FIG. 14 is a side view of a stretching device according to an eighth embodiment of the present invention.

FIG. 15 is a perspective view of a stretching device according to a ninth embodiment of the present invention.

### BEST MODE

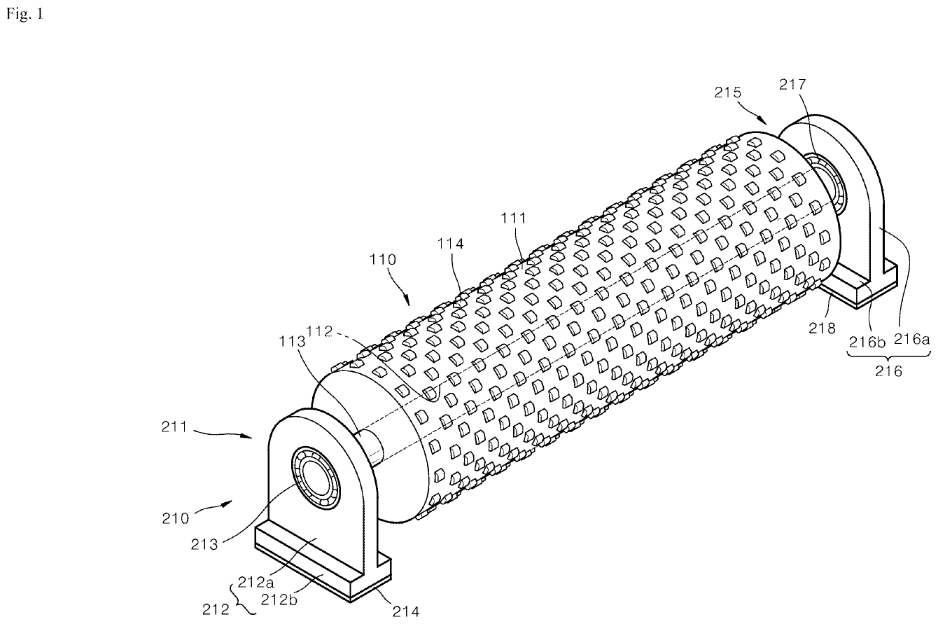

Hereinafter, a stretching device according to preferred embodiments of the present invention will be described with reference to the accompanying drawings. FIG. 1 shows a stretching device according to a first embodiment of the present invention.

Referring to FIG. 1, the stretching device according to the first embodiment of the present invention includes a foam roller part 110 having a cylindrical shape with a predetermined length, disposed in parallel with the ground, and capable of supporting a user's body by allowing the user to lie on an outer circumferential surface of the foam roller part, and a support part 210 that rotatably supports the foam roller part 110.

The foam roller part 110 includes a main body portion 111 formed in a tubular shape and a shaft portion 113 inserted through the main body portion 111.

The main body portion 111 has an annular cross section. The main body portion 111 is formed to be long so that the user can easily lean against the same. The main body portion 111 has a hollow portion 112 penetrating in a length direction and formed on an inner side forming a concentric circle with an outer circumferential surface. The main body portion 111 is formed on the outer circumferential surface with protrusions 114 or groove portions (not shown) so that the user can easily roll the body while leaning against the outer circumferential surface. The main body portion 111 is formed of a material such as sponge or polyurethane foam. The main body portion 111 is preferably made of a material that the user can feel soft and comfortable when leaning against the same. In the first embodiment of the present invention, an example in which one main body portion 111 is coupled to one shaft portion 113 is shown. However, a configuration may also be applied in which a plurality of main body portions 111 are coupled to one shaft portion 113.

The protrusion 114 is formed in a hexahedral shape. Unlike the first embodiment of the present invention, for the protrusion 114, a configuration may be applied in which a member formed of one or more selected from plastic, acupressure stone, and magnet is installed on the outer circumferential surface of the main body portion 111.

The shaft portion 113 has a circular cross section and extends by a predetermined length. The shaft portion 113 has an outer diameter corresponding to an inner diameter of the hollow portion 112 of the main body portion 111. The shaft portion 113 is formed longer than a length of the main body portion 111 so that first and second bearing blocks 211 and 216 described below can be coupled to both end portions thereof. The shaft portion 113 is press-fitted to the hollow portion 112. The shaft portion 113 is configured to rotate integrally with the main body portion 111. Alternatively, the shaft portion 113 and the main body portion 111 may be coupled with each other so that they do not rotate relative to each other by applying an adhesive on surfaces in contact with each other. In addition, the main body portion 111 may be formed in an annular structure joined to the shaft portion 113 by winding a plate-like material in a roll form on the shaft portion, unlike the shown example.

The support part 210 includes first and second bearing blocks 211 and 215 that are spaced apart from each other along the length direction of the shaft portion 113 and rotatably support the shaft portion 113.

The first and second bearing blocks 211 and 215 include first and second bearings 213 and 217 coupled to both end portions of the shaft portion 113, and first and second bearing housings 212 and 216 that support the first and second bearings 213 and 217 at a predetermined height.

The first and second bearing housings 212 and 216 are spaced apart from each other and disposed side by side at an interval longer than the length of the main body portion 111. The first and second bearing housings 212 and 216 include first and second bearing supports 212a and 216a provided with bearing insertion holes into which the first and second bearings 213 and 217 can be coupled, and first and second supporters 212b and 216b that support the first and second bearing supports 212a and 216a from lower portions. The first and second supporters 212b and 216b are formed such that they extend from lower ends of the first and second bearing supports 212a and 216a in greater widths than widths of the first and second bearing supports 212a and 216a so as to stably support the first and second bearing supports 212a and 216b.

The bearing insertion holes are formed as through-holes at positions where the first and second bearings 213 and 217 are coaxial with each other. The first and second bearing housings 212 and 216 support the first and second bearings 213 and 217 at a height higher than a radius of the main body portion 111.

The first and second bearings 213 and 217 each have an outer ring fitted and fixed to each bearing insertion hole of the first and second bearing housings 212 and 216, and an inner ring concentric with the outer ring inside the outer ring and capable of relative rotation. The first and second bearings 213 and 217 are ball bearings or roller bearings. The outer rings of the first and second bearings 213 and 217 are mounted in the bearing insertion holes of the first and second bearing housings 212 and 216. Both end portions of the shaft portion 113 are mounted on the inner rings of the first and second bearings 213 and 217. With this configuration, the shaft portion 113 is rotatably supported with respect to the first and second bearing housings 212 and 216. In the present embodiment, the configuration in which the shaft portion 113 is coupled to and is rotatably supported by the first and second bearings 213 and 217 is shown. Unlike this configuration, a configuration may also be applied in which the shaft portion 113 is formed to have an outer diameter corresponding inner diameters of the bearing insertion holes of the first and second bearing housings 212 and 216, and the shaft portion 113 is rotatably fitted directly into and coupled with the bearing insertion holes to be rotatable.

In order to prevent the first and second bearing housings 212 and 216 from slipping with respect to the ground, the first and second bearing housings 212 and 216 are preferably mounted with first and second anti-slip members 214 and 218 on lower portions. For the first and second anti-slip members 214 and 218, rubber pads that generate sufficient frictional force between the pads and the ground are applied. The first and second anti-slip members 214 and 218 prevent the first and second bearing housings 212 and 216 from slipping due to a pressing force applied from the user's body.

The stretching device according to the first embodiment of the present invention configured as described above is supported on the ground via the first and second anti-slip members 214 and 218. In the stretching device according to the first embodiment of the present invention, the user may get stretching exercise while rotating the main body portion 111 by moving the user's body forward and backward in a state where the user supports the user's body on the outer circumferential surface of the main body portion 111.

In the stretching device according to the first embodiment of the present invention, the foam roller part 110 is rotatably supported by the first and second bearing blocks 211 and 215. With this configuration, even when the user moves the user's body forward and backward, the foam roller part 110 is rotated in place, so that a space required for the user to get stretching exercise is limited to a distance that the user moves the user's body forward and backward for the stretching exercise, and thus the space can be efficiently used.

In addition, since a position of the foam roller part with respect to the ground is maintained while the user gets stretching exercise, the user's body moves relative to the ground by the distance that the user moves the user's body forward and backward to roll the foam roller part 110, so that it is easy for the user to estimate a moving distance of the user's body, thereby reducing a risk of injuries by hitting the head against a wall.

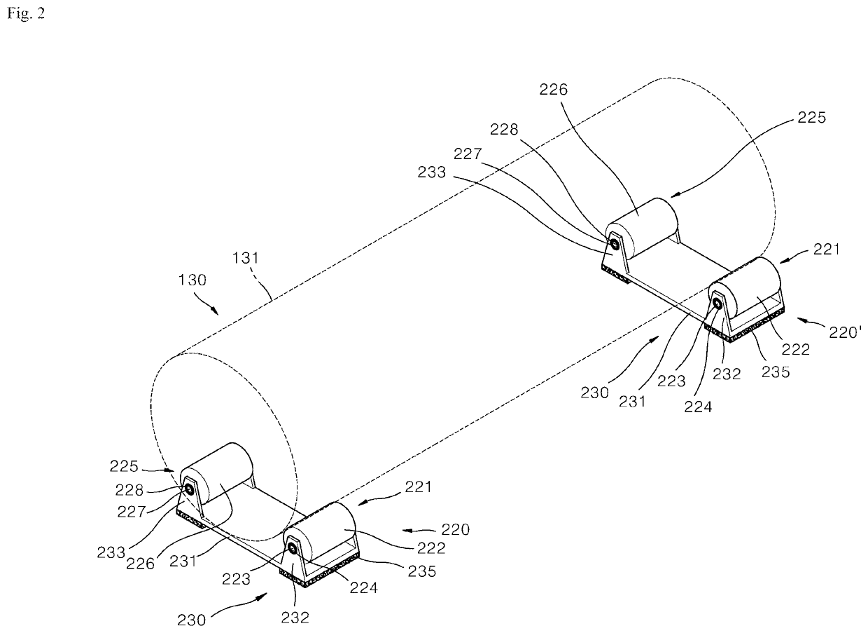

FIG. 2 shows a stretching device according to a second embodiment of the present invention.

The stretching device according to the second embodiment of the present invention includes a foam roller part 130 having a cylindrical shape with a predetermined length, disposed in parallel with the ground, and capable of supporting a user's body by allowing the user to lie on an outer circumferential surface of the foam roller part, and support parts 220 and 220′ that rotatably support the outer circumferential surface of the foam roller part 130.

The foam roller part 130 may include only a cylindrical main body portion 131 having a circular cross section and extending by a predetermined length. The main body portion 131 may have a configuration in which protrusions 114 are provided on the outer circumferential surface, as in the main body portion 111 of the first embodiment of the present invention.

The support parts 220 and 220′ shown in FIG. 2 include a first support part 220 for supporting one end portion of the foam roller part 130 and a second support part 220′ for supporting the other end portion so as to support both end portions in the length direction of the foam roller part 130 from lower portions. The first and second support parts 220 and 220′ have the same configuration.

Unlike the present embodiment, when first and second support roller parts 221 and 225 described below are extended to a length sufficient to support the outer circumferential surface of the foam roller part 130 along the length direction, a configuration in which only the first support part 220 is included may be applied.

The first support part 220 rotatably supports the outer circumferential surface along the length direction of the foam roller part 130 at a mutually spaced position in a state where the foam roller part 130 is restrained.

The first support part 220 includes first and second support roller parts 221 and 225 arranged to have axis lines parallel to each other, and a roller supporter 230 that rotatably supports the first and second support roller parts 221 and 225.

The first and second support roller parts 221 and 225 include a pair of first and second support wheels 222 and 226 aligned side by side, first and second support roller rotation shafts 223 and 227 extending from both end portions of the first and second support wheels 222 and 226, and first and second support roller bearings 224 and 228 coupled to both end portions of each of the first and second support roller rotation shafts 223 and 227.

The first and second support wheels 222 and 226 are each formed in a cylindrical shape having a rotation axis parallel to the foam roller part 130. The first and second support roller rotation shafts 223 and 227 extend from both end portions of the first and second support wheels 222 and 226 so as to have outer diameters smaller than outer diameters of the first and second support wheels 222 and 226. The first and second support wheels 222 and 226 and the first and second support roller rotation shafts 223 and 227 have the same axis lines, respectively.

For the first and second support roller bearings 224 and 228, roller bearings or ball bearings each having an inner ring and an outer ring capable of relative rotation with each other may be applied. Both end portions of the first and second support roller rotation shafts 223 and 227 are coupled to the inner rings of the first and second support roller bearings 224 and 228.

The roller supporter 230 includes a support base 231, and first and second support pieces 232 and 233 for supporting the first and second support roller bearings 224 and 228 at a predetermined height with respect to the support base 231.

The support base 231 has a predetermined thickness and is formed in a rectangular plate shape. At least one anti-slip member 235 made of rubber is preferably attached to a lower surface of the support base 231 so that the support base 231 does not slip with respect to the ground by a pressing force applied from a user.

The first and second support pieces 232 and 233 extend upward from an upper surface of the support base 231. A pair of first support pieces 232 are formed upward from end portions on one side of the support base 231 so as to support both end portions of the first support roller rotation shaft 223. A pair of second support pieces 233 are formed upward from end portions on the other side of the support base 231 so as to support both end portions of the second support roller rotation shaft 223. The outer ring of the first support roller bearing 224 is installed on the first support piece 232, and the second support roller bearing 228 is supported by the second support piece 233.

The first and second support pieces 232 and 233 are formed to have smaller widths than diameters of the first and second support wheels 222 and 226 so that upper end portions, at which the first and second support roller bearings 224 and 228 are installed, do not interfere with the outer circumferential surface of the foam roller part 130 supported by the first and second support wheels 222 and 226. Lower end portions of the first and second support pieces 232 and 233 are formed wide so as to sufficiently distribute the user's weight applied through the first and second support wheels 222 and 226. That is, the first and second support pieces 232 and 233 are each preferably formed in a trapezoidal shape.

In the stretching device according to the second embodiment of the present invention as described above, the foam roller part 130 does not move forward or backward even when the foam roller part 130 rotates during the stretching exercise.

In addition, the stretching device according to the second embodiment of the present invention can be installed by placing the foam roller part 130 on the first and second support wheels 222 and 226, and therefore, has an advantage in that various types of foam roller parts 130 available on the market can be quickly replaced and used.

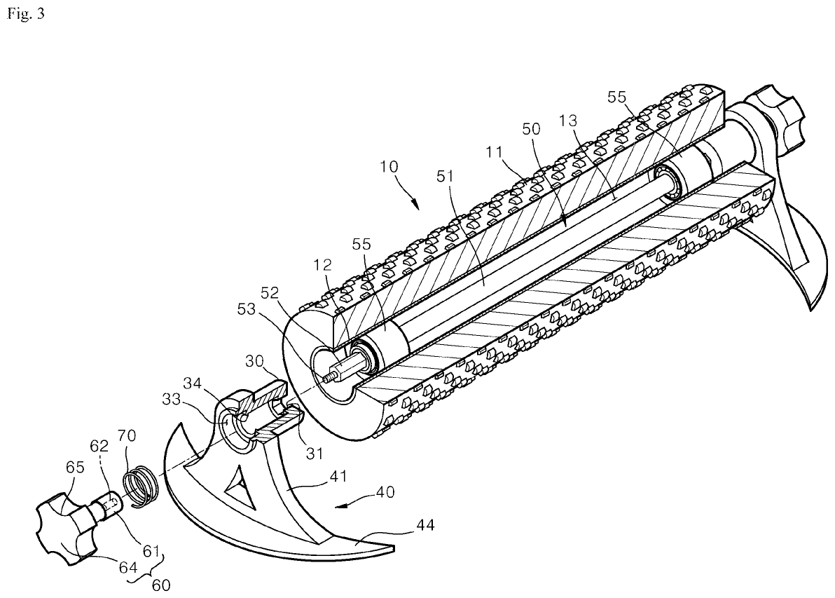

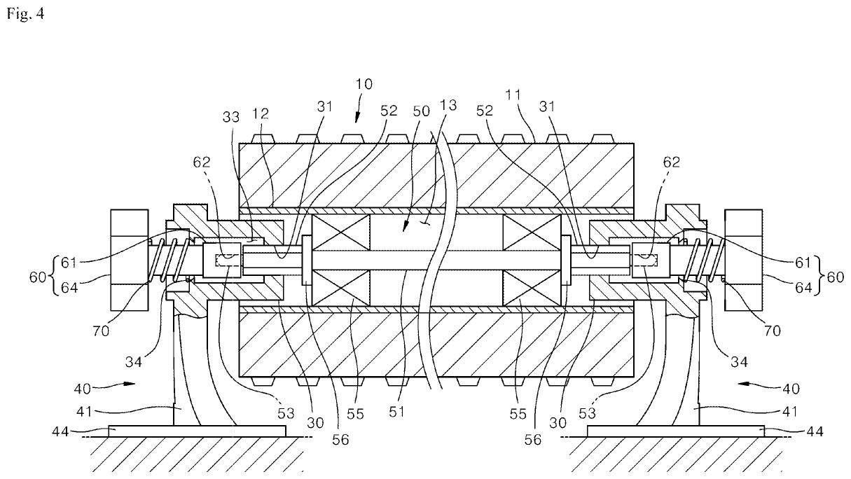

FIGS. 3 to 5 show a stretching device according to a third embodiment of the present invention.

A foam roller part 10 is formed in a tubular shape having a hollow portion penetrating along a length direction.

The foam roller part 10 includes a tubular main body portion 11 having a hollow portion 13, and a support tube body 12 installed inside the main body portion 11.

The main body portion 11 has the same configuration as that of the main body portion 111 of the first embodiment of the present invention described above.

The support tube body 12 is formed in a tubular shape so that a moving part described below can be accommodated therein. The support tube body 12 is installed in the hollow portion 13 of the main body portion 11. The support tube body 12 is fitted into the hollow portion 13 of the main body portion 11 so as to rotate together with the main body portion 11.

A support part includes a pair of supporters disposed on both sides of the foam roller part 10, and a moving part that is coupled to the supporters to rotatably support the foam roller part 10, and moves together with the foam roller part 10 to prevent the supporters from moving when an external force is applied along the length direction of the foam roller part 10.

The pair of supporters are arranged to sandwich the foam roller part 10 therebetween. The supporters are each disposed so that an insertion hole 31 described below faces toward the foam roller part 10.

The supporter includes a holder 30 provided with an insertion hole 31 into which the moving part is inserted and coupled to be movable in the length direction of the foam roller part 10, and a base 40 for supporting the holder 30.

The moving part includes a support shaft 50 disposed in the hollow portion 13 and having both end portions inserted into and coupled to the insertion holes 31, bearings 55 installed on the support shaft 50 to rotatably support the foam roller part 10, movement limiting caps 60 installed at both end portions of the support shaft 50 to limit movement in the length direction of the support shaft 50, and elastic members 70 each installed to elastically support the movement limiting cap 60 with respect to the holder 30 and to attenuate a pressing force transmitted from the user in the length direction of the foam roller part 10.

The holder 30 is formed in a cylindrical shape. The holder 30 has therein an accommodation space 33. The holder 30 is formed to have an outer diameter smaller than an inner diameter of the support pipe body 12 so that one side where the insertion hole 31 is formed can be accommodated in the support pipe body 12.

The insertion hole 31 is formed on one side of the holder 30. The insertion hole 31 communicates with the accommodation space 33. The insertion hole 31 is formed in a shape corresponding to a cross section of a fitting portion 52 of the support shaft 50 described below. In the third embodiment of the present invention, the insertion hole 31 is formed to have a hexagonal cross section.

The other side of the holder 30 is opened so that the movement limiting cap 60 can be inserted into the accommodation space 33. A support protrusion 34 is formed on an inner circumferential surface of the accommodation space 33 so that one side of the elastic member 70 described below can be supported.

The support shaft 50 is formed shorter than the main body portion 11. The support shaft 50 includes a bearing coupling portion 51 formed in a rod shape, fitting portions 52 formed at both end portions of the bearing coupling portion 51, and threaded portions 53 each formed at an end portion of the fitting portion 52.

The bearing coupling portion 51 is formed to have a circular cross section.

The fitting portions 52 extend from both end portions of the bearing coupling portion 51 in a direction away from each other. The fitting portion 52 is formed in a hexagonal cross section.

The threaded portion 53 extends from each end portion of the fitting portion 52. A thread is formed on an outer circumferential surface of the threaded portion 53 so that the threaded portion is screwed into a thread groove 62 described below.

The fitting portion 52 of the support shaft 50 is inserted into the insertion hole so that the threaded portion 53 is put into the accommodation space 33.

The bearing 55 has the same configuration as that of the first or second bearing 213, 217 of the first embodiment of the present invention. The inner ring of the bearing 55 is fitted into the bearing coupling portion 51. The outer ring of the bearing 55 is fitted into the support tube body 12. The support shaft 50 rotatably supports the support tube body 12 via the bearing 55.

A restraining ring 56 for preventing the bearing 55 from flowing along the length direction of the bearing coupling portion 51 is installed on the bearing coupling portion 51.

The movement limiting cap 60 includes a support shaft coupling portion 61 and a handle portion 64.

The support shaft coupling portion 61 is formed in a cylindrical shape that can be accommodated in the accommodation space 33 of the holder 30. The support shaft coupling portion 61 is formed to have a larger outer diameter than the insertion hole 31. The support shaft coupling portion 61 is formed with a screwing groove 62 for screwing the threaded portion 53 on one-side end face.

The handle portion 64 extends from the other side of the support shaft coupling portion 61 to have a larger outer diameter than the support shaft coupling portion 61. The handle portion 64 is formed with a plurality of gripping grooves 65 along a circumferential direction on the outer circumferential surface so that a user can easily grip the handle portion.

The base 40 includes a vertical portion 41 extending downward from an outer circumferential surface of the holder 30 and a horizontal portion 44 formed at a lower portion of the vertical portion 41.

The vertical portion 41 extends to gradually increase in width. The horizontal portion 44 is formed in a plate shape with a greater width than the vertical portion 41. The anti-slip member of the first embodiment of the present invention as described above is preferably attached to a lower surface of the horizontal portion 44.

For the elastic member 70, a coil spring that exerts a restoring force in a direction in which a length is increased when compressed by an external force is applied. The elastic member 70 is installed to surround the support shaft coupling portion 61. The elastic member 70 is installed to elastically support the movement limiting cap 60 with respect to the holder 30 by having one side in close contact with the support protrusion 34 and the other side in close contact with the handle portion 65.

In the stretching device according to the third embodiment of the present invention as described above, while the user gets stretching exercise by moving the user's body forward and backward in a state in which the user supports the user's back or abdomen on the upper outer circumferential surface of the foam roller part 10, a pressing force is applied along the length direction of the foam roller part 10 according to the user's posture.

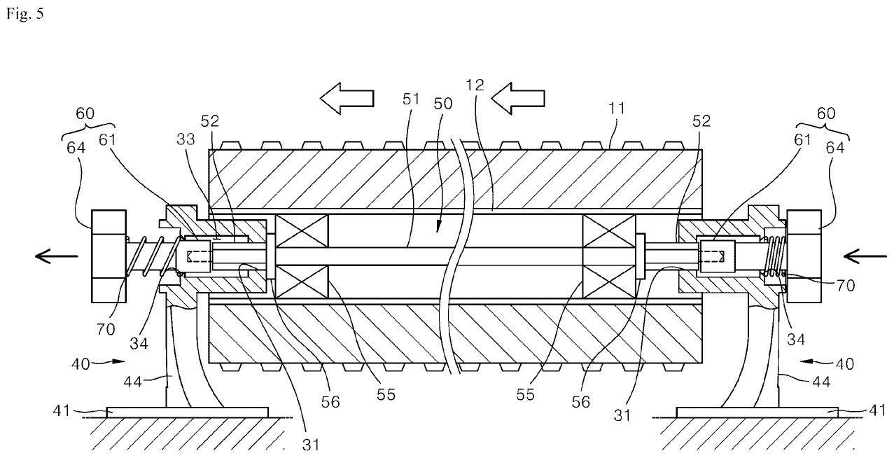

At this time, in the stretching device according to the third embodiment of the present invention, as shown in FIG. 5, the foam roller part 10 moves in the direction of the arrow along the length direction together with the moving part, and the pressing force applied in the length direction of the foam roller part 10 is prevented from being transmitted to the base 40, whereby the base 40 is prevented from slipping and the user's exercise posture is prevented from being lost.

In addition, in the stretching device according to the third embodiment of the present invention, the pressing force transmitted to the base 40 via the foam roller part 10 and the moving part is relieved by the elastic member 70, so that the slipping phenomenon of the base is more effectively prevented.

Further, in the stretching device according to the third embodiment of the present invention, the positions of the foam roller part 10 and the moving part are aligned to the center between the holders 30 by the elastic members 70, so that an operational effect of correcting the user's exercise posture is exhibited.

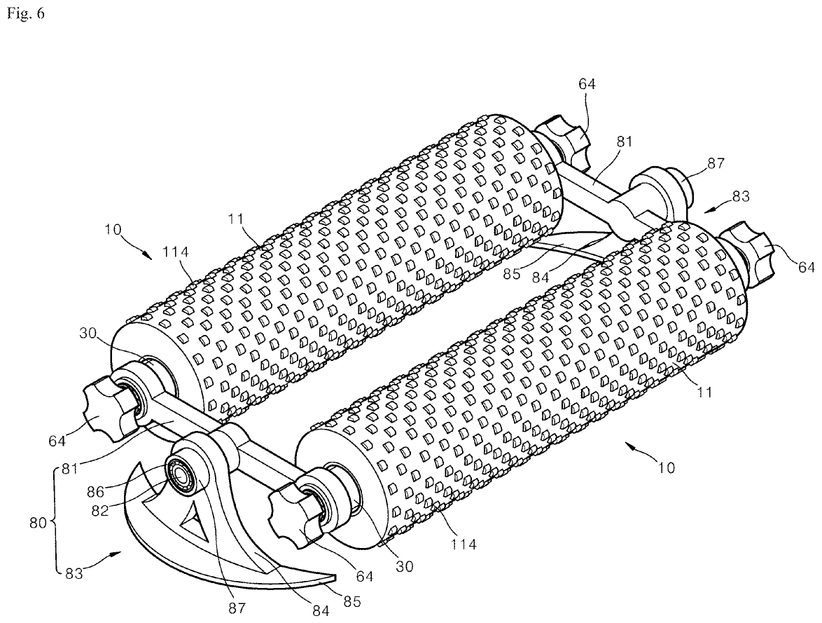

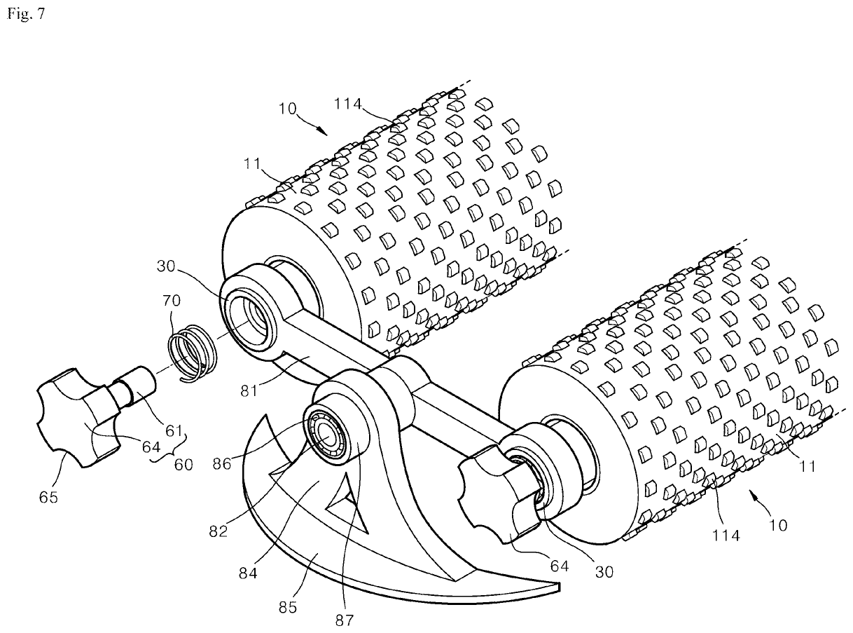

FIGS. 6 and 7 show a stretching device according to a fourth embodiment of the present invention.

Referring to the drawings, the stretching device according to the fourth embodiment of the present invention is the same as the third embodiment, except the numbers of the foam roller part 10, the moving part, and the holder 30 and the configuration of a base 80, and thus, the overlapping descriptions will be omitted.

A pair of foam roller parts 10 are spaced apart from each other and are arranged side by side. The foam roller part 10 has the same configuration as that of the foam roller part 10 of the third embodiment of the present invention.

The moving part has the same configuration as that of the moving part of the third embodiment of the present invention. The moving part is installed in the hollow portion of each of the foam roller parts 10.

A pair of holders 30 are disposed on each of both sides of the respective foam roller parts 10. The holder 30 has the same configuration as that of the holder 30 of the third embodiment of the present invention.

The base 80 includes a connecting rod 81 interconnecting the holders 30 for supporting the foam roller parts 10, and a tilting stand 83 for supporting the connecting rod 81 in a tiltable manner.

The connecting rod 81 interconnects the holders 30 for supporting the foam roller parts 10 and the moving parts, which are arranged spaced apart from each other. The connecting rod 81 is provided with a rotation shaft 82 for hinge-coupling with the tilting stand 83 at a center of its length.

The tilting stand 83 includes a vertical portion 84 extending vertically and a plate-like horizontal portion 85 formed wide at a lower portion of the vertical portion 84.

A bearing support 87 for rotatably supporting the connecting rod 81 is formed in an upper portion of the vertical portion 84. The bearing support 87 is formed in a cylindrical shape so that an outer ring of a bearing 86 can be fitted therein.

The bearing 86 is installed in the bearing support 87.

The connecting rod 81 is rotatably supported by the vertical portion 84 as the rotation shaft 82 is coupled to an inner ring of the bearing 86 installed in the bearing support 87.

In the stretching device according to the fourth embodiment of the present invention, the connecting rod 81 is supported to be tiltable in a direction of an arrow shown in FIG. 6 so that the foam roller parts 10 are aligned at different heights.

The stretching device according to the fourth embodiment of the present invention as described above has an advantage of allowing the user to get stretching exercises at various angles and postures by inclining the foam roller parts 10 to form various angles.

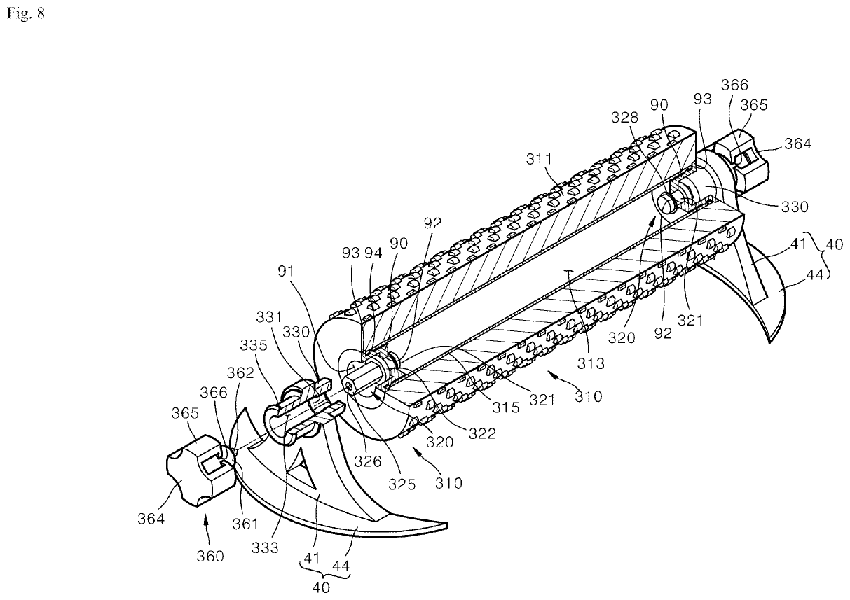

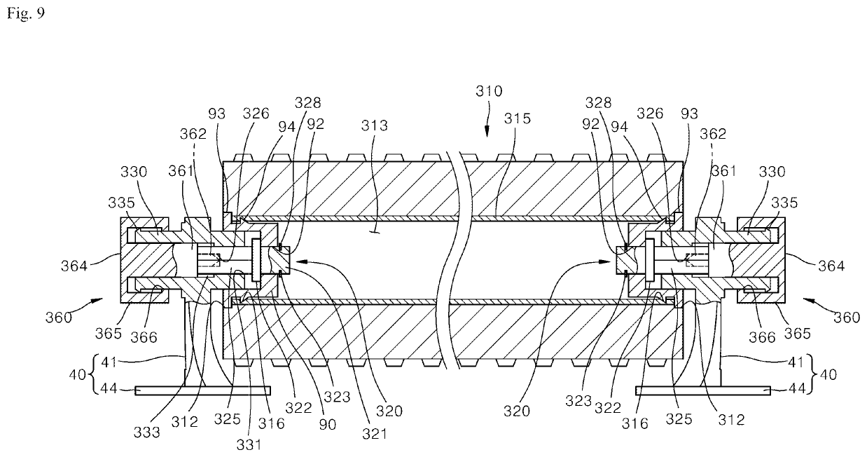

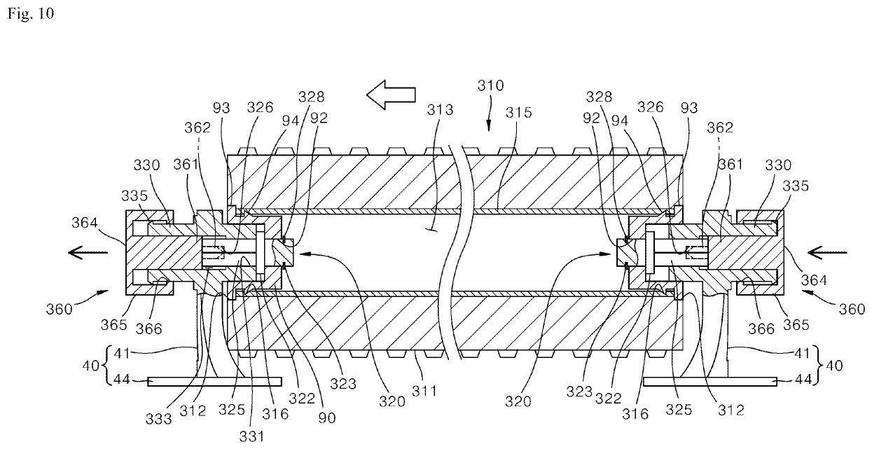

FIGS. 8 to 10 show a stretching device according to a fifth embodiment of the present invention. Referring to the drawings, the stretching device according to the fifth embodiment of the present invention is an embodiment to which a modified configuration of the moving part and the supporter according to the third embodiment of the present invention is applied.

A main body portion 311 has the same configuration as that of the main body portion 11 of the third embodiment of the present invention, except a configuration in which supporting protrusion insertion grooves 312 are formed.

The supporting protrusion insertion grooves 312 are recessed from both ends of the main body portion 311. The supporting protrusion insertion groove 312 is formed to have a larger diameter than that of a hollow portion 313. The supporting protrusion insertion groove 312 communicates with the hollow portion 313.

A support tube body 315 has the same shape as that of the support tube body 12 of the third embodiment of the present invention, except a configuration in which bearing coupling grooves 316 described below are formed. The support tube body 315 is formed to have a shorter length by a length of the supporting protrusion insertion groove 312 than the support tube body 12 of the third embodiment of the present invention.

The bearing coupling grooves 316 are formed on inner circumferential surfaces of both end portions of the support tube body 315, respectively. The bearing coupling groove 316 is formed along a circumferential direction of the support tube body 315.

For a bearing 90, a journal bearing is applied. The bearing 90 is formed in a cylindrical shape where an insertion space 91 opened on one side is provided therein. The bearing 90 is formed on the other side with a journal insertion hole 92 into which a support shaft can be inserted and coupled. The journal insertion hole 92 communicates with the insertion space 91. The journal insertion hole 92 is formed in a circular shape. The bearing 90 has a supporting protrusion 93 formed on an outer circumferential surface of an end portion on one side. The bearing 90 has a bearing coupling protrusion 94 protruding from the outer circumferential surface at a position spaced apart from the supporting protrusion 93 in the other direction. The bearing coupling protrusion 94 is formed in a shape corresponding to the bearing coupling groove 316.

The bearing 90 is inserted into and coupled to the hollow portion 313. The bearing coupling protrusion 94 is fitted into the bearing coupling groove 316 to prevent the bearing 90 from separating from the support tube body 315. The supporting protrusion 93 is coupled to the supporting protrusion insertion groove 312 to prevent the main body portion 311 from slipping from the support tube body 315 and moving in the length direction.

A pair of support shafts 320 are provided to be coupled to each bearing 90. The support shaft 320 includes a journal portion 321 formed in a rod shape and a fitting portion 325 extending from an end portion on one side of the journal portion 321.

The journal portion 321 is formed to have a circular cross section with an outer diameter corresponding to the bearing coupling groove 316. A bearing supporting protrusion 322 protrudes from an outer circumferential surface on one side of the journal portion 321 in the length direction. A snap ring fitting groove 323 into which a snap ring 328 can be mounted is formed on an outer circumferential surface of the journal portion 321 at a position spaced apart from the bearing supporting protrusion 322 in the other direction. The snap ring 328 limits movement of the bearing 90 in the length direction together with the supporting protrusion 322 in a state where the journal portion 321 is inserted into the bearing coupling groove 316. The outer circumferential surface of the journal portion 321 and the inner circumferential surface of the bearing coupling groove 316 are in sliding contact with each other, so that the journal portion 321 rotatably supports the bearing 90.

The fitting portion 325 has the same configuration as that of the fitting portion 52 of the third embodiment of the present invention. A thread groove 326 is formed at a terminal end of the fitting portion 325.

The holder 330 is formed in a cylindrical shape. The holder 30 has therein an accommodation space 333. The holder 330 is formed to have an outer diameter smaller than an inner diameter of the bearing 90 so that one side where the insertion hole 331 is formed can be accommodated in the insertion space 91 of the bearing 90.

The insertion hole 331 is formed on one side of the holder 330. The insertion hole 331 communicates with the accommodation space 333. The insertion hole 331 is formed in a shape corresponding to the cross section of the fitting portion 325. The other side of the holder 330 is opened so that the movement limiting cap 360 can be inserted into the accommodation space 333. A locking protrusion 335 is formed on the outer circumferential surface of the other end portion of the holder 330 so that a locking step 366 of the movement limiting cap 360 described below can be locked.

The movement limiting cap 360 includes a support shaft coupling portion 361 and a handle portion 364.

The support shaft coupling portion 361 is formed in the same shape as the support shaft coupling portion 61 of the third embodiment of the present invention. A threaded portion 362 that can be screwed into the thread groove 326 is provided on an end face on one side of the support shaft coupling portion 361.

The handle portion 364 is formed in the same shape as the handle portion 64 of the third embodiment of the present invention. The handle portion 364 is formed with an extension bar 365 extending parallel to the support shaft coupling portion 361 from an end face on one side. A locking step 366 protruding in a direction toward the support shaft coupling portion 361 is formed at a terminal end of the extension bar 365.

The base 40 has the same configuration as that of the base 40 of the third embodiment of the present invention.

In the stretching device according to the fifth embodiment of the present invention, the configuration in which the elastic member is omitted is applied. However, when a configuration in which the same elastic member 70 as in the third embodiment of the present invention described above is coupled to the support shaft coupling portion 361 is applied, the same operational effects as the stretching device according to the third embodiment of the present invention can be exhibited.

In the stretching device according to the fifth embodiment of the present invention, the bearing coupling protrusion 94 is coupled to the bearing coupling groove 316, thereby preventing the bearing 90 from flowing in the length direction of the foam roller part 310.

In addition, in the stretching device according to the fifth embodiment of the present invention, the main body portion 311 is prevented from slipping with respect to the support tube body 315 by the supporting protrusion 93, so that a phenomenon that the foam roller part 40 and the bearing 90 are separated while the user uses the stretching device according to the fifth embodiment of the present invention is prevented.

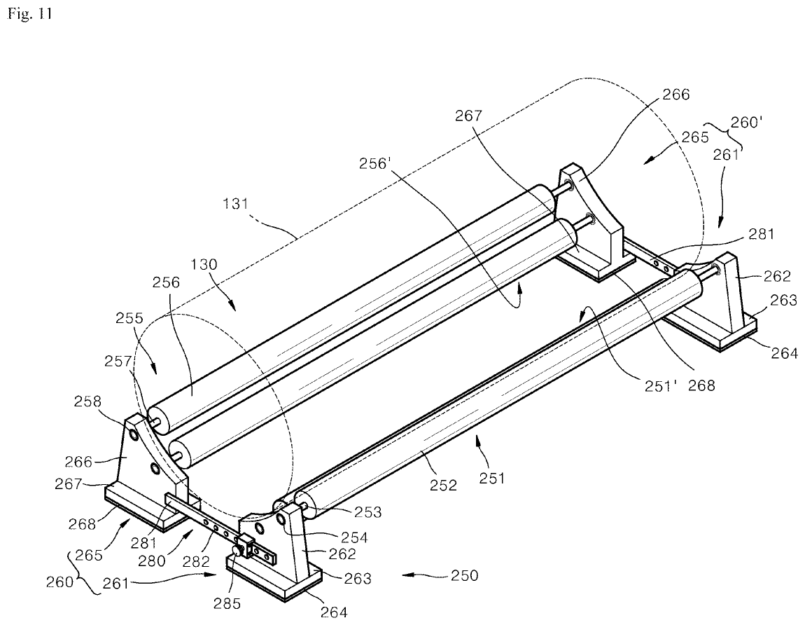

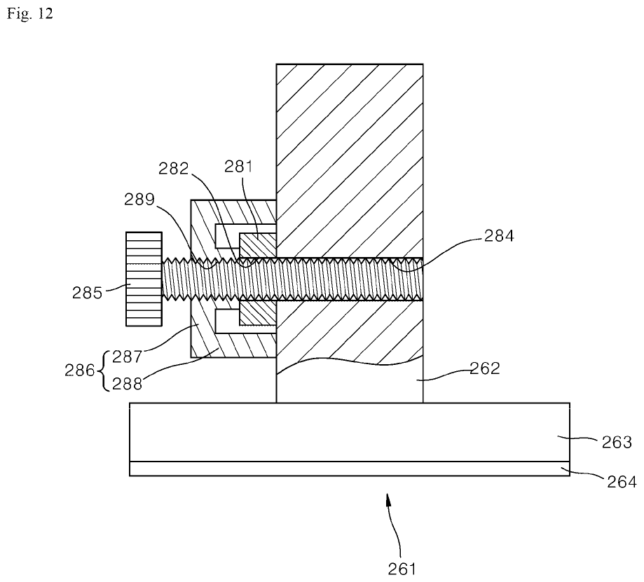

FIGS. 11 and 12 show a stretching device according to a sixth embodiment of the present invention. In the stretching device according to the sixth embodiment of the present invention, since the foam roller part 130 is the same as that of the third embodiment, the overlapping description will be omitted.

Referring to the drawings, a support part 250 of the stretching device according to the sixth embodiment of the present invention further includes an interval adjusting part 280 capable of varying an interval between a first support roller part 251 and a second support roller part 255.

Roller supporters 260 and 260′ are installed in a pair on each of both sides of the first and second support roller parts 251 and 255 so that they are respectively installed at both end portions of the first and second support roller parts 251 and 255 to rotatably support the first and second support roller parts 251 and 255. The roller supporters 260 and 260′ each have the same configuration.

Each of the roller supporters 260 and 260′ includes first and second roller supporters 261 and 265 that individually and rotatably support the first and second support roller parts 251 and 255 and are spaced apart from each other at a predetermined interval.

The first roller supporter 261 includes a first roller bracket 262 that rotatably supports the first support roller part 251, and a first roller supporting plate 263 that supports the first roller bracket 262 at a lower portion. The first roller supporting plate 263 is formed in a rectangular plate shape. A plate-like first anti-slip member 264 that is in contact with the ground to prevent the first roller supporting plate 263 from slipping with respect to the ground and exhibits a frictional force is preferably attached to a lower portion of the first roller supporting plate 263. The first roller bracket 262 extends from an upper end of the first roller supporting plate 263 to a predetermined height and is erected on the first roller supporting plate 263.

The first support roller part 251 includes a first wheel 252, first support roller rotation shafts 253 formed at both end portions of the first wheel 252, and first support roller bearings 254 coupled to the first support roller rotation shafts 253.

The first wheel 252 has a circular cross section and extends in the horizontal direction. The first wheel is aligned to have an axis line parallel to the axis line of the foam roller part 130. The first wheel 252 extends by a length sufficient to support the foam roller part 130. The first support roller rotation shafts 253 extend from both end portions of the first wheel 252, respectively.

The first support roller bearings 254 are installed on both sides of the first support roller rotation shaft 253. The first support roller bearing 254 is installed in the first roller bracket 262, so that the first wheel 252 is rotatably supported with respect to the first roller bracket 262.

In addition, a first auxiliary support roller part 251′ is further provided which has a rotation axis parallel to the first support roller part 251, is installed to be rotatably supported by the first roller supporter 261 and can support the foam roller part 130 in an auxiliary manner. The first auxiliary support roller part 251′ may have the same configuration as that of the first support roller part 251.

The second roller supporter 265 includes a second roller bracket 266 that rotatably supports the second support roller part 255, and a second roller supporting plate 267 that supports the second roller bracket 266 at a lower portion. The second roller supporting plate 267 is formed in a rectangular plate shape. A plate-like second anti-slip member 268 that is in contact with the ground to prevent the second roller supporting plate 267 from slipping with respect to the ground and exhibits a frictional force is preferably attached to a lower portion of the second roller supporting plate 267. The second roller bracket 266 extends from an upper end of the second roller supporting plate 267 to a predetermined height and is erected on the second roller supporting plate 267.

The second support roller part 255 includes a second support wheel 256, second support roller rotation shafts 257 formed at both end portions of the second support wheel 256, and second support roller bearings 258 coupled to the second support roller rotation shafts 257.

The second support wheel 256 has a circular cross section and extends in the horizontal direction. The second support wheel 256 is aligned to have an axis line parallel to the axis line of the foam roller part 130. The second support wheel 256 extends to a length sufficient to support the foam roller part 130. The second support roller rotation shafts 257 extend from both end portions of the second support wheel 256, respectively.

The second support roller bearings 258 are installed on both sides of the second support roller rotation shaft 257. The second support roller bearing 258 is installed in the second roller bracket 266, so that the second support wheel 256 is rotatably supported with respect to the second roller bracket 266.

In addition, a second auxiliary support roller part 256′ is further provided which has a rotation shaft parallel to the second support roller part 255, is installed to be rotatably supported by the second roller supporter 265 and can support the foam roller part 130 in an auxiliary manner. The second auxiliary support roller part 256′ may have the same configuration as that of the second support roller part 256.

The interval adjusting part 280 includes an interval adjusting guide 281 extending by a predetermined length, having one side fixed to the second roller supporter 265 and formed with a plurality of interval adjusting holes 282, and an interval fixing member 285 coupled to an interval fixing hole 284 formed in the first roller supporter 261 so as to be coaxial with at least one of the interval adjusting holes 282 and the interval adjusting hole 282.

The interval control guide 281 is formed in a rectangular tube shape extending by a predetermined length. The interval control guide 281 extends in the horizontal direction orthogonal to the axis line of the foam roller part 130. The plurality of interval adjusting holes 282 are spaced apart at regular intervals along the length direction, and are formed to penetrate an outer circumferential surface of the interval adjusting guide 281. One side of the interval adjusting guide 281 is fixed to an outer surface of the first roller bracket 262. The interval adjusting guide 281 is disposed so that the other side is in contact with the outer surface of the first roller bracket 262.

The interval fixing hole 284 is formed to penetrate the outer surface of the first roller bracket 262 of the first roller supporter 261. The interval fixing hole 284 is formed at a height corresponding to a height of the interval adjusting hole 282 formed in the interval adjusting guide 281. The interval fixing hole 284 is formed to penetrate in a direction parallel to the penetrating direction of the interval adjusting hole 282 of the interval adjusting guide 281. The interval fixing hole 284 is preferably formed to have the same diameter as that of the interval adjusting hole 282.

In addition, the first roller bracket 282 is provided with an interval fixing member support bracket 286 capable of supporting the interval fixing member 285 to be able to advance and retreat. The interval fixing member support bracket 286 includes a plate-like screw coupling portion 287 and a screw coupling portion support member 288 extending from both end portions of the screw coupling portion 287 toward the first roller bracket 262. The screw coupling portion 287 is disposed at a position spaced from the outer surface of the first roller bracket 262 by a predetermined interval. The screw coupling portion 287 is formed on an inner side with a screw coupling hole 289 penetrating along the penetrating direction of the interval fixing hole 284 at a position coaxial with the interval fixing hole 284. The screw coupling hole 289 is formed at a position coaxial with the interval fixing hole 284. A thread is formed on an inner circumferential surface of the screw coupling hole 289 so that the interval fixing member 285 can be screwed.

For the interval fixing member 285, a bolt that can be screwed into the screw coupling hole 289 is applied. The interval fixing member 285 is provided on one side with a handle so that the user can hold and rotate the same, and the other side is screwed with the screw coupling portion 287 through the screw coupling hole 289. The interval fixing member 285 advances in a direction in which an end portion on the other side is directed toward the interval fixing hole 284 by being rotated in a forward direction, or retreats by being rotated in a reverse direction.

The interval fixing member 285 is rotated in the forward direction by a user's operation and is inserted into the interval adjusting hole 282 and the interval fixing hole 284 coaxial with each other, thereby fastening the interval adjusting guide 281 and the first roller bracket 262 each other. In addition, the interval fixing member is rotated in the reverse direction by a user's operation and is separated from the interval adjusting hole 282 and the interval fixing hole 284, thereby releasing the fastened state of the interval adjusting guide 281 and the first roller bracket 262.

In the stretching device according to the sixth embodiment of the present invention as described above, the interval between the first and second support roller parts 251 and 255 can be adjusted by a method in which the user adjusts the interval between the first and second support roller parts 251 and 255 to be close to or away from each other in a state in which the fastening of the interval fixing member 285 is released and then fastens the interval fixing member 285.

With this configuration, the stretching device according to the sixth embodiment has an advantage in that the foam roller part 130 having a different outer diameter can be used in various ways according to the body shape or exercise method.

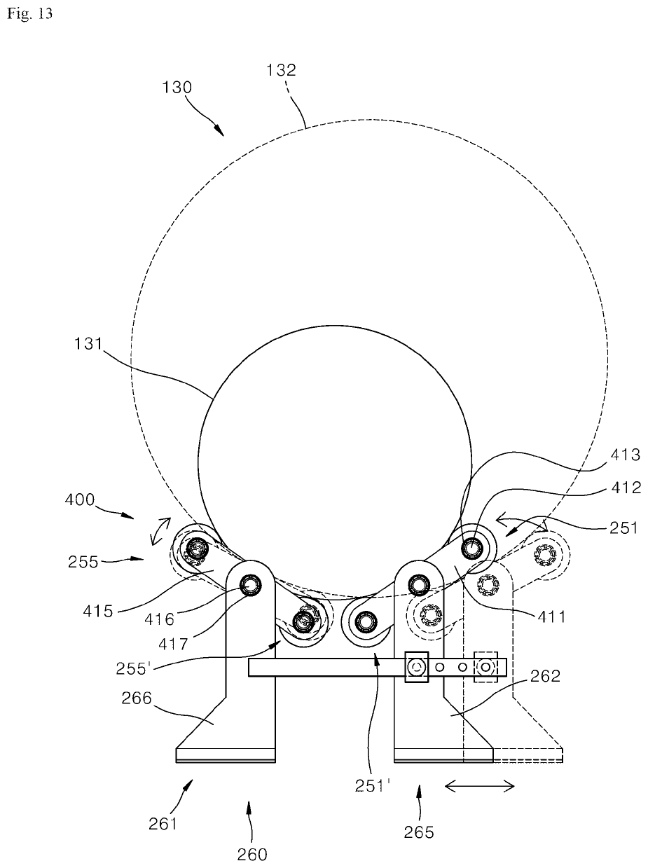

FIG. 13 shows a stretching device according to a seventh embodiment of the present invention.

Since the stretching device according to the seventh embodiment of the present invention has the same configuration as that of the stretching device according to the third embodiment of the present invention, except the first and second roller supporters 261 and 265, the overlapping description will be omitted.

The first and second roller supporters 261 and 265 further include an aligning unit 400 for aligning the plurality of first and second support roller parts 251 and 255 and the first and second auxiliary support roller parts 251′ and 255′ to contact an outer circumferential surface of the same radius of curvature from a center of the roller part 130 having a changed outer diameter.

The aligning unit 400 includes first and second aligning brackets 411 and 415 rotatably installed in the respective upper portions of the first and second roller brackets 262 and 266.

The first and second aligning brackets 411 and 415 each extend to a predetermined length. The first and second aligning brackets 411 and 415 have first and second aligning bracket rotation shafts 412 and 416 provided between one side and the other side in the length direction, capable of being coupled to the first and second roller brackets 262 and 266 and extends in parallel with the rotation axis of the foam roller part 130.

The first and second roller brackets 262 and 266 are formed with through-holes to which first and second aligning bracket support bearings 413 and 417 described below can be coupled.

The first and second aligning bracket support bearings 413 and 417 may be of the same type as the first and second support roller bearings 254 and 258. The first and second aligning bracket support bearings 413 and 417 are installed so that outer rings are supported at a predetermined height by the first and second roller brackets 262 and 266. The first and second aligning bracket rotation shafts 412 and 416 are coupled to the inner rings of the first and second aligning bracket support bearings 413 and 417, so that the first and second aligning brackets 411 and 415 can be rotatably supported by the first and second roller brackets 262 and 266.

The first and second support roller parts 251 and 255 and the first and second auxiliary support roller parts 251′ and 255′ have the same configuration as that of the sixth embodiment of the present invention. The first support roller part 251 and the first auxiliary support roller part 251′ are rotatably installed on one side and the other side of the first aligning bracket 411 in the length direction, respectively. The second support roller part 255 and the second auxiliary support roller part 255′ are rotatably installed on one side and the other side of the second aligning bracket 415 in the length direction, respectively.

In the aligning unit 400 as described above, the first and second support roller parts 251 and 255 and the first and second auxiliary support roller parts 251′ and 255′ are rotatably installed in the first and second aligning brackets 411 and 415 rotatably supported by the first and second roller brackets 262 and 266. Thereby, even in a state where the main body portion 131 of the foam roller part 130 is replaced with another main body portion 132 having a larger outer diameter, the aligning unit is adaptively rotated to align the first and second support roller parts 251 and 255 and the first and second auxiliary support roller parts 25l′ and 255′ so as to be located at the same radius of curvature from a center of the other main body portion 132, making it possible to support the main body portion 131 more stably.

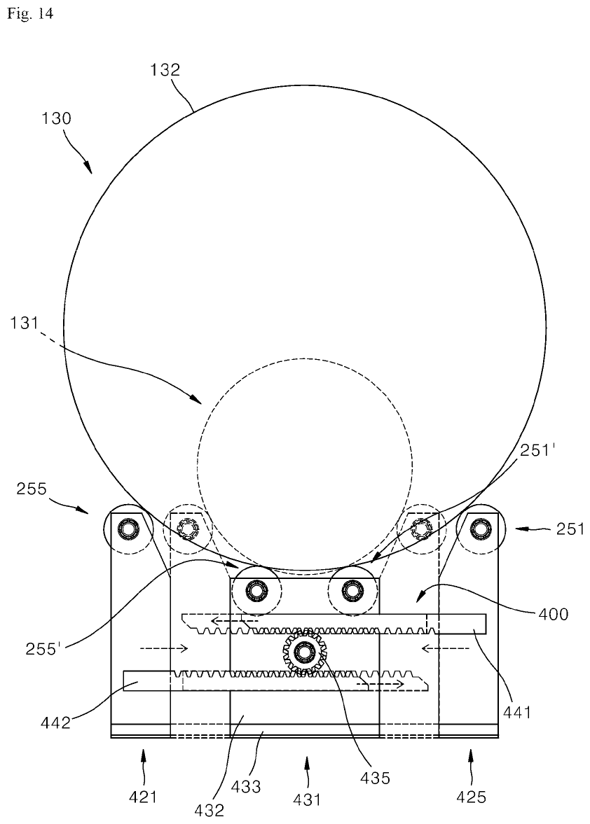

Note that FIG. 14 shows a stretching device according to an eighth embodiment of the present invention. Referring to the drawing, since the configurations other than the roller supporter and the interval adjusting part are the same as those of the sixth embodiment of the present invention, the overlapping descriptions will be omitted.

The first and second support roller parts 251 and 255 and the first and second auxiliary support roller parts 251′ and 255′ have the same configuration as that of the sixth embodiment of the present invention.

The roller supporters are installed at both end portions of the first and second support roller parts 251 and 255, respectively. A pair of roller supporters are installed at both end portions of the first and second support roller parts 251 and 255 so as to rotatably support the first and second support roller parts 251 and 255, respectively.

Each roller supporter includes first and second roller supporters 421 and 425 that rotatably support the first and second support roller parts 251 and 255 individually and are disposed spaced apart from each other at a predetermined interval, and an auxiliary roller supporter 431 installed between the first and second roller supporters 421 and 425. The first and second roller supporters 421 and 425 have the same configuration as that of the sixth embodiment of the present invention.

The auxiliary roller supporter 431 includes an auxiliary roller bracket 432 for rotatably supporting the first and second auxiliary support roller parts 251′ and 255′, and an auxiliary roller supporting plate 433 for supporting the auxiliary roller bracket 432 from a lower portion. The auxiliary roller supporting plate 433 is formed in a rectangular plate shape. A plate-like auxiliary anti-slip member 435 that is in contact with the ground to prevent the roller supporting plate 433 from slipping with respect to the ground and exhibits a frictional force is preferably attached to a lower portion of the roller supporting plate 433. The auxiliary roller bracket 432 extends from the top of the auxiliary roller supporting plate 433 to a predetermined height and is erected on the auxiliary roller supporting plate 433.

The first and second auxiliary support roller parts 251′ and 255′ are installed in the upper portion of the auxiliary roller bracket 432. The first and second auxiliary roller parts 25l′ and 255′ are spaced apart from each other and arranged to have parallel axis lines so that the outer circumferential surface along the length direction of the foam roller part 130 can be rotatably supported in a restrained state of the foam roller part 130. The first and second auxiliary support roller parts 251′ and 255′ are installed side by side on one side and the other side of the auxiliary roller bracket 432, respectively, along the horizontal direction orthogonal to the axis line of the foam roller part 130.

The interval adjusting part 400 includes a first rack gear 442 extending along the horizontal direction by a predetermined length and having one side fixed to the first roller supporter 421 and the other side installed adjacent to the auxiliary supporter 431, a second rack gear 441 extending along the horizontal direction by a predetermined length and having one side fixed to the second roller supporter 425 and the other side installed adjacent to the auxiliary supporter 431, and a pinion gear 435 installed on the auxiliary supporter 431 to move the first and second rack gears 442 and 441 in a direction in which the first roller supporter 421 and the second roller supporter 425 come closer to or are away from each other.

The pinion gear 435 is rotatably installed on a side of the auxiliary roller bracket 432 so as to have an axis line parallel to the foam roller part 130. The pinion gear 435 is formed with a gear having a constant tooth shape along an outer circumferential surface. The pinion gear 435 may further include a handle installed to be rotated at the same rotating speed as the pinion gear 435 at a coaxial position and allowing a user to conveniently rotate the pinion gear 435 by gripping the handle.

The first and second rack gears 442 and 441 are vertically spaced apart from each other at an interval corresponding to an outer diameter of the pinion gear 435. The first and second rack gears 442 and 441 are formed on surfaces facing each other with gears corresponding to the teeth of the gear formed on the outer circumferential surface of the pinion gear 435. The first and second rack gears 442 and 441 are in mesh with upper and lower portions of the pinion gear 435, respectively.

In the interval adjusting part 400 configured as described above, when the user rotates the pinion gear 43 in the forward and reverse direction, the first and second roller supporters 421 and 425 move away from or toward each other with the same distance from the auxiliary roller supporter 431 all the time. Thereby, even when the main body portion 131 of the foam roller part 130 is replaced with another main body portion 132 having a larger outer diameter, the first and second roller supporters are located at the same radius of curvature from a center of the other main body portion 132, and thus, can support the outer circumferential surface of the foam roller part 130 more stably.

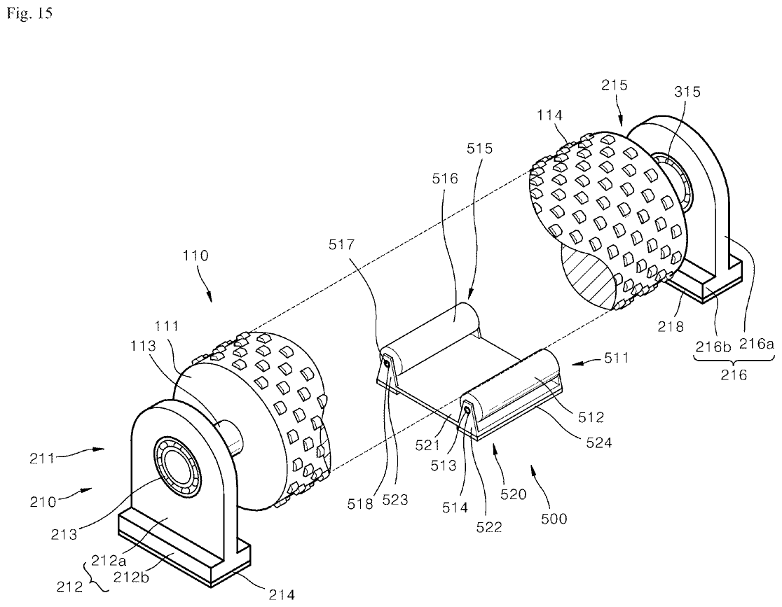

FIG. 15 shows a stretching device according to a ninth embodiment of the present invention. In the stretching device according to the ninth embodiment of the present invention, components other than an anti-depression part 500 are the same as those in the first embodiment, and therefore, the overlapping description will be omitted.

The stretching device according to the ninth embodiment of the present invention further includes an anti-depression part 500 for preventing a part between one side and the other side of the foam roller part 110 from being depressed due to a load applied from a user.

The anti-depression part 500 includes first and second anti-depression roller parts 511 and 515 each having a rotation shaft parallel to the foam roller part 110 and spaced apart from each other and arranged to have axis lines parallel to each other so that the outer circumferential surface along the length direction of the foam roller part 110 can be rotatably supported in a restrained state of the foam roller part 110, and an anti-depression roller supporter 520 for rotatably supporting the first and second anti-depression roller parts 511 and 515.

The first and second anti-depression roller parts 511 and 515 include a pair of first and second anti-depression wheels 512 and 516 parallel to each other, first and second anti-depression roller rotation shafts 513 and 517 extending from both end portions of the first and second anti-depression wheels 512 and 516, and first and second anti-depression roller bearings 514 and 518 installed on the first and second anti-depression roller rotation shafts 513 and 517.

The first and second anti-depression wheels 512 and 516 are formed in a cylindrical shape having a rotation axis parallel to the foam roller part 110. The first and second anti-depression roller rotation shafts 513 and 517 extend to have outer diameters smaller than outer diameters of the first and second anti-depression wheels 512 and 516 from both end portions of the first and second anti-depression wheels 512 and 516. The first and second anti-depression wheels 512 and 516 and the first and second anti-depression roller rotation shafts 513 and 517 have the same axis line, respectively.

The first and second anti-depression roller bearings 514 and 518 are coupled to both end portions of the first and second anti-depression roller rotation shafts 513 and 517, respectively. For the first and second anti-depression roller bearings 514 and 518, usual roller bearings or ball bearings composed of inner and outer rings capable of relative rotation with each other may be applied. The first and second anti-depression roller rotation shafts 513 and 517 are coupled to the inner rings of the first and second anti-depression roller bearings 514 and 518, respectively.

The anti-depression roller supporter 520 includes an anti-depression roller base 521, and first and second anti-depression roller support pieces 522 and 523 for supporting the first and second anti-depression roller bearings 514 and 518 at a predetermined height with respect to the anti-depression roller base 521.

The anti-depression roller base 521 has a predetermined thickness and is formed in a rectangular plate shape. At least one anti-slip member 524 made of rubber is preferably attached to a lower surface of the anti-depression roller base 521 so that the anti-depression roller base 521 does not slip with respect to the ground by a pressing force applied from a user.

A pair of first anti-depression roller support pieces 522 are formed upward from end portions on one side of the anti-depression roller base 521 so as to support end portions of the first anti-depression roller rotation shaft 513. A pair of second anti-depression roller support pieces 523 are formed upward from end portions on the other side of the anti-depression roller base 521 so as to support both end portions of the second anti-depression roller rotation shaft 517.

The first and second anti-depression roller support pieces 522 and 523 extend upward from the upper surface of the anti-depression roller base 521. The outer ring of the first anti-depression roller bearing 514 is installed to be supported by the first anti-depression roller support piece 522, and the outer ring of the second anti-depression roller bearing 518 is installed to be supported by the second anti-depression roller support piece 523, so that the first and second anti-depression wheels 512 and 516 are rotatably supported with respect to the anti-depression roller supporter 520.

The first and second anti-depression roller support pieces 522 and 523 are formed to have smaller widths than diameters of the first and second anti-depression wheels 512 and 516 so that the upper portions, at which the first and second anti-depression roller bearings 514 and 518 are installed, do not interfere with the outer circumferential surface of the foam roller part 110 supported by the first and second anti-depression wheels 512 and 516. Lower portions of the first and second anti-depression roller support pieces 522 and 523 are formed wide so as to sufficiently support the user's weight applied through the first and second anti-depression wheels 512 and 516. That is, the first and second anti-depression roller support pieces 522 and 523 are preferably formed in a trapezoidal shape.

In the stretching device according to the ninth embodiment of the present invention as described above, a situation where the foam roller part 110 is bent downward in a state in which the user leans the user's body against the foam roller part 110 and the user's weight is applied to the foam roller part 110, and therefore, the user's exercise effect is reduced or the user's body is supported at an incorrect posture is prevented to improve the exercise effect.

While the present invention has been described with reference to the embodiments shown in the drawings, one skilled in the art will understand that the embodiments are only exemplary and various modifications and equivalent embodiments can be made from the embodiments. Therefore, the true technical protection scope of the present invention should be determined by the technical spirit of the attached claims.

1. A stretching device comprising:
a foam roller part having a cylindrical shape with a predetermined length, disposed in parallel with the ground, and configured to be able to support a user's body by allowing the user to lie on an outer circumferential surface of the foam roller part; and
a support part configured to rotatably support the foam roller part.

2. The stretching device of claim 1, wherein the support part comprises first and second support roller parts each having a rotation axis parallel to the foam roller part and spaced apart from each other and arranged to have axis lines parallel to each other so that an outer circumferential surface along a length direction of the foam roller part can be rotatably supported in a restrained state of the foam roller part, a roller supporter configured to rotatably support the first and second support roller parts.

3. The stretching device of claim 1, wherein the support part comprises:
a pair of supporters disposed on both sides of the foam roller part, and
a moving part coupled to the supporters to rotatably support the foam roller part, and configured to move together with the foam roller part to prevent movement of the supporters when an external force is applied along a length direction of the foam roller part.

4. The stretching device of claim 3, wherein the foam roller part is formed in a tubular shape having a hollow portion penetrating along the length direction,
wherein the supporters each comprise a holder provided with an insertion hole into which the moving part is movably inserted in the length direction of the foam roller part, and a base configured to support the holder, and
wherein the moving part comprises a support shaft disposed in the hollow portion and having both end portions inserted into and coupled to the insertion holes, a bearing installed on the support shaft to rotatably support the foam roller part, and movement limiting caps installed at both end portions of the support shaft and configured to limit movement of the support shaft in the length direction.

5. The stretching device of claim 4, wherein the moving part further comprises elastic members installed to elastically support the movement limiting caps with respect to the holders and to attenuate a pressing force transmitted from a user in the length direction of the foam roller part.

6. The stretching device of claim 4, wherein the foam roller part is provided in a pair of foam roller parts spaced apart from each other and arranged side by side, and
wherein the supporters each comprise a connecting rod configured to interconnect the holders configured to support the foam roller parts, and a tilting stand configured to support the connecting rod in a tiltable manner.

7. The stretching device of claim 2, wherein the support part further comprises an interval adjusting part configured to be able to vary an interval between the first support roller part and the second support roller part,
wherein the roller supporter comprises first and second roller supporters configured to individually rotatably support the first and second support roller parts and spaced apart from each other at a predetermined interval, and
wherein the interval adjusting part comprises an interval adjusting guide extending by a predetermined length, having one side fixed to the second roller supporter and formed with a plurality of interval adjusting holes spaced apart from each other at regular intervals along a length direction on an outer circumferential surface, and an interval fixing member coupled to an interval fixing hole formed in the first roller supporter so as to be coaxial with at least one of the interval adjusting holes and the interval adjusting hole.

8. The stretching device of claim 1, further comprising an anti-depression part configured to prevent depression of a part between one side and the other side of the foam roller part by a load applied from a user,
wherein the anti-depression part comprises first and second anti-depression parts each having a rotation axis parallel to the foam roller part and spaced apart from each other and arranged to have axis lines parallel to each other so that an outer circumferential surface along a length direction of the foam roller part can be rotatably supported in a restrained state of the foam roller part, and an anti-depression roller supporter configured to rotatably support the first and second anti-depression roller parts.
